(19) United States
(12) Patent Application Publication
(10) Pub. No.: US 2021/0224533 A1
(43) Pub. Date: Jul. 22, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Tomoyuki SHIMIZU, Kanagawa (JP)

(73) Assignee: FUJI XEROX CO., LTD., Tokyo (JP)

(21) Appl. No.: 16/927,931

(22) Filed: Jul. 13, 2020

(30) Foreign Application Priority Data
Jan. 17, 2020 (JP) 2020-005957

(51) Int. Cl. G06K 9/00; G06K 9/62; G06F 16/9535; G06F 16/2457

(52) U.S. Cl. CPC G06K 9/00463; G06F 16/24578; G06F 16/9535; G06K 9/6212

(57) ABSTRACT

An information processing apparatus includes a storage device, and a processor configured to execute calculation of degrees of similarity between an interest document element and document elements associated with the interest document element for each associated document element, and execute display control for the associated document elements based on the degrees of similarity between the associated document elements and the interest document element obtained by the calculation and past degrees of similarity stored in the storage device.

### CROSS-REFERENCE TO RELATED APPLICATIONS

This application is based on and claims priority under 35 USC 119 from Japanese Patent Application No. 2020-005957 filed Jan. 17, 2020.

### BACKGROUND

### (i) Technical Field

The present invention relates to an information processing apparatus and a non-transitory computer readable medium storing a program.

### (ii) Related Art

There is a system that specifies a document element of another document similar to a document element of a certain document and notifies a user of information on the specified document element.

For example, a contract analysis system described in JP5383943B executes processing for generating a document vector of each article of a plurality of law articles included in a plurality of laws, processing for generating an article group obtained by combining a plurality of articles having similarity equal to or greater than a predetermined threshold value by comparing the document vectors of each article, processing for generating the document vectors for each article group for each article group, processing for generating the document vectors for each article for the input contract data, processing for specifying, as an association article of a contract article, each law article included in the most similar article group by comparing the document vectors for each article with the document vectors for each article group, and processing for generating an analysis result screen on which the association articles are listed for each contract article.

### SUMMARY

For example, in a case where a first document element is modified, a second document element associated with the first document element may be modified according to the modification. In such a case, there is a possibility that the modified first document element is not similar to the second document element. Thus, it is not possible to specify the second document element after the modification of the first document element and notify the user by a method of specifying another document element similar to the document element and notifying the user.

Aspects of non-limiting embodiments of the present disclosure relate to an information processing apparatus and a non-transitory computer readable medium storing a program that information on another document element associated with a document element can be displayed according to a change in a degree of similarity between the two document elements due to the modification in a case where the document element is modified.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a storage device, and a processor configured to execute calculation of degrees of similarity between an interest document element and document elements associated with the interest document element for each associated document element, and execute display control for the associated document elements based on the degrees of similarity between the associated document elements and the interest document element obtained by the calculation and past degrees of similarity stored in the storage device.

### BRIEF DESCRIPTION OF THE DRAWINGS

Exemplary embodiment (s) of the present invention will be described in detail based on the following figures, wherein:

FIG. 1 is a diagram illustrating a configuration of an entire system including a document service system;

FIG. 2 is a diagram illustrating a hardware configuration of a computer in which the document service system is installed;

FIG. 3 is a diagram for describing a case where a document is divided into document elements and a degree of similarity between the document elements is calculated;

FIG. 4 is a diagram illustrating an example of a screen provided to the user by the document service system and illustrating a change in the degree of similarity between a modified document element and an associated document element;

FIG. 5 is a diagram illustrating another example of the screen which is provided to a user by the document service system and illustrates the change in the degree of similarity between the modified document element and the associated document element;

FIG. 6 is a diagram illustrating still another example of the screen which is provided to the user by the document service system and illustrates the change in the degree of similarity between the modified document element and the associated document element;

FIG. 7 is a diagram illustrating still another example of the screen which is provided to the user by the document service system and illustrates the change in the degree of similarity between the modified document element and the associated document element;

FIG. 8 is a diagram illustrating a part of an association table;

FIG. 9 is a diagram illustrating a processing procedure executed by the document service system in a case where the user requests that information on a document element of interest is displayed;

FIG. 10 is a diagram illustrating the change in the degree of similarity due to the modification of the document element in the association table;

FIG. 11 is a diagram illustrating a processing procedure executed by the document service system in order to perform maintenance of the association table; and

FIG. 12 is a diagram illustrating a notification screen generated by a maintenance processing procedure.

### DETAILED DESCRIPTION

Example of Overall System

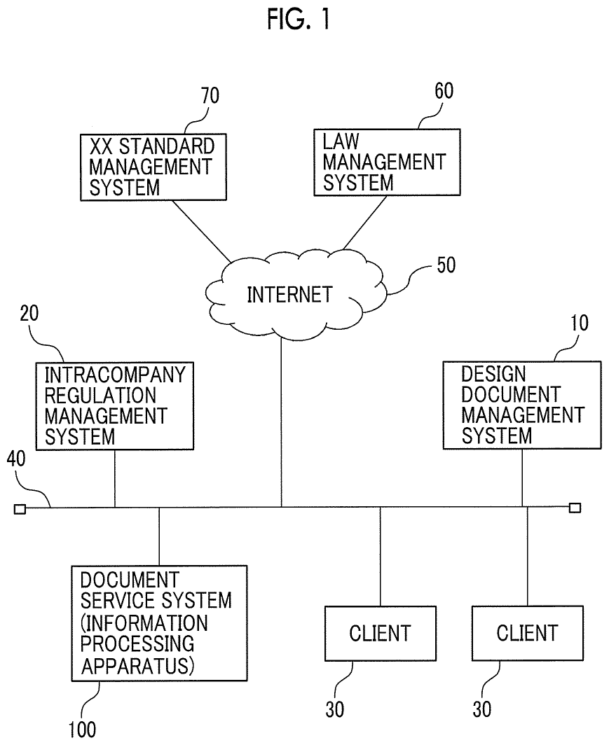

FIG. 1 illustrates an overall system for using a document including a document service system 100 which is an exemplary embodiment of an information processing apparatus according to the exemplary embodiment of the present invention.

In this example, the document service system 100 is connected to an intracompany network 40 of a certain company. One or more document management systems for managing various documents in the company such as a design document management system 10 and an intracompany regulation management system 20 are connected to the intracompany network 40. A client 30 such as a personal computer operated by a user is connected to the intracompany network 40.

Various document management systems such as a law management system 60 and an XX standard management system 70 that manages standard documents of an “XX” technology are present on the Internet 50. Apparatuses such as the document service system 100 and the client 30 on the intracompany network 40 can access the documents of the document management system on the Internet 50.

The document service system 100 detects changes in the documents in various document management systems on the intracompany network 40 or the Internet 50, and provides information on the detected changes to the user.

Here, the “document” is data in any data format, and the data format is not particularly limited. For example, the document may be data in a text data format, or may be various document file formats such as a PDF format. The document may be image data in various image data formats, may be moving image data, or may be data in a structured document format such as Hypertext Markup Language (HTML) format or eXtensible Markup Language (XML) format.

The document is configured to include one or more document elements. For example, in a case where the document is configured to include a plurality of chapters, each chapter is the document element constituted to be included in the document. In a case where the chapter in the document is configured to include a plurality of sections, the section is the document element that has a level different from the chapter but is configured to be included in the document. In a case where the chapter is regarded as one document, the section is the document element configured to constitute the document (=chapter). In a case where one law such as the patent law is regarded as the document, individual articles configured to constitute this law and individual paragraphs configured to constitute each article are the document elements configured to constitute the document (=law). In the case of a document described in HTML, a part enclosed by a start tag and a corresponding end tag is one document element.

The document service system 100 divides each document registered in each document management system into document element units, and manages each document element. The document may be divided into the document element units by using the related art.

Example of Hardware Configuration

The document service system 100 is realized by causing a computer to execute a program representing a function of the system.

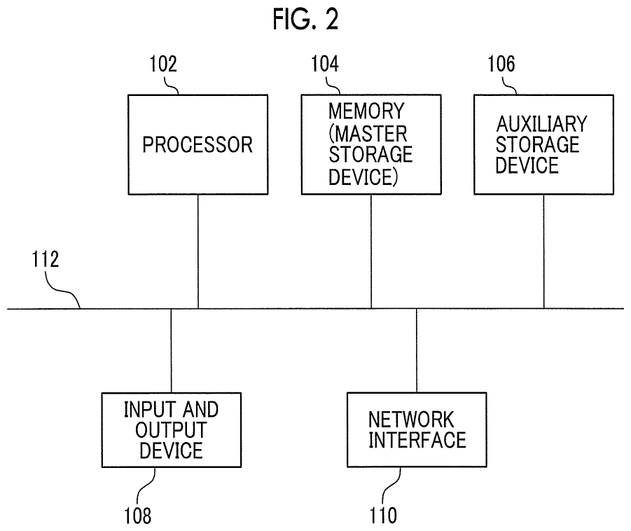

Here, as illustrated in FIG. 2, for example, the computer serving as a base of the document service system 100 includes as hardware, a circuit configuration in which a processor 102, a memory (master storage device) 104 such as a random access memory (RAM), a controller that controls an auxiliary storage device 106 which is a nonvolatile storage device such as a flash memory, a solid state drive (SSD), or a hard disk drive (HDD), an interface with various input and output devices 108, and a network interface 110 that performs control for connection with a network such as a local area network are connected via a data transmission path such as a bus 112. A program that describes processing contents of functions of the document service system 100 is installed in a computer via a network, and is stored in the auxiliary storage device 106. The functions of the document service system 100 are realized by the processor 102 executing the program stored in the auxiliary storage device 106 by using the memory 104.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

An operation of the processor 102 may be performed not only by one processor 102 but also in cooperation with a plurality of processors 102 present at physically separated positions. Each operation of the processor 102 is not limited to only an order described in the following exemplary embodiment, and may be appropriately changed.

Other apparatuses such as the design document management system 10, the intracompany regulation management system 20, and the client 30 are also configured to use the computer as the base in the same manner as the document service system 100.

Example of Providing Information Regarding Change in Document

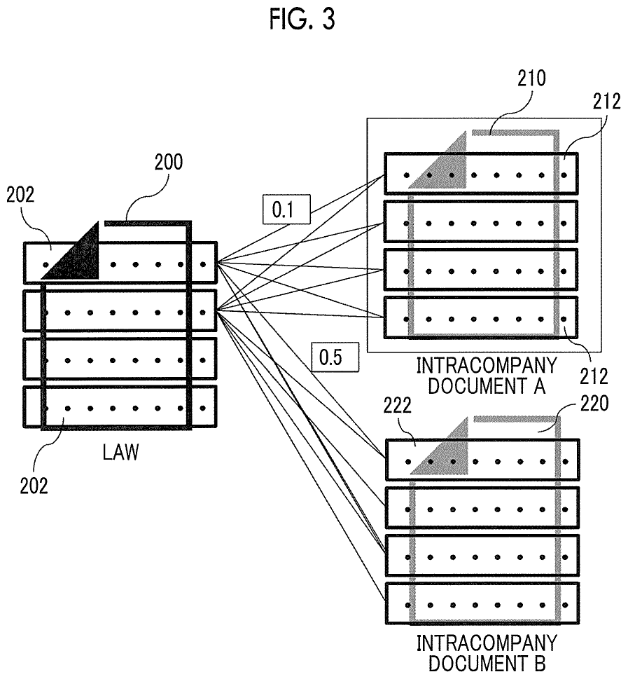

As illustrated in FIG. 3, the document service system 100 divides documents 200, 210, and 220 into document elements 202, 212, and 222, respectively, and calculates degrees of similarity between the document elements. In the illustrated example, a degree of similarity between the first document element 202 of the document 200 called “law” and the first document element 212 of the document 210 called “intracompany document A” is 0.1, and a degree of similarity between the first document element 202 of the document 200 and the first document element 222 of the document 220 called “intracompany document B” is 0.5.

In this exemplary embodiment, for example, the document service system 100 classifies the documents into intracompany documents and extracompany documents, and monitors degrees of similarity between the document elements of the intracompany documents and the document elements of the extracompany documents. The intracompany documents are the documents managed by the document management system in the company on the intracompany network 40, for example, the design document management system 10 and the intracompany regulation management system 20. Meanwhile, in the example of FIG. 1, the extracompany documents are the documents managed by the document management system, for example, the law management system 60 on the Internet 50 outside the intracompany network 40. In the example of FIG. 3, the documents 210 and 220 are the intracompany documents, and the document 200 is the extracompany document. In this example, the document service system 100 provides the information to the user according to a change in the calculation result of the degree of similarity between each document element of each intracompany document and each document element of each extracompany document from the previous calculation result.

That is, the document service system 100 provides, to the user, a display screen illustrating changes in the degrees of similarity between the document element of which the content is modified and other document elements associated with the corresponding document element before and after the modification. For example, information on the modified content of the modified document element and information indicating the changes in the degrees of similarity between the corresponding document element and the other document elements are displayed on this screen. The other document elements associated with the document element of interest are sorted and displayed on this screen according to the degrees of similarity to the document element of interest.

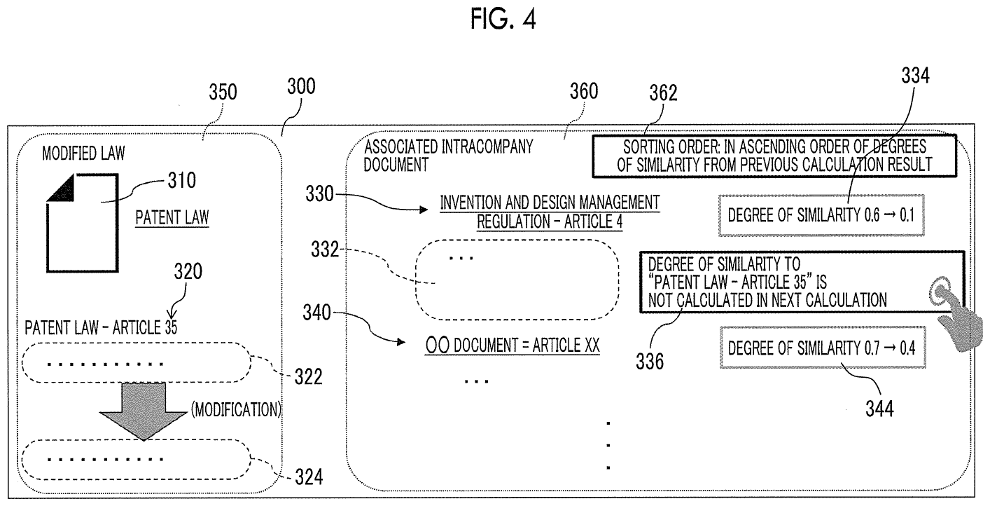

For example, a screen 300 illustrated in FIG. 4 is an example of a screen provided by the document service system 100 in a case where a content of a document element 320 (element name “Article 35”) of an extracompany document 310 (document name “Patent Law”) is modified from a content 322 to a content 324. The modified document element 320 is the document element of interest. The screen 300 includes two left and right display regions 350 and 360. Information on the extracompany document element is displayed in the left display region 350, and information on the intracompany document element associated with the extracompany document element is displayed in the right display region 360. Information on the modified extracompany document element 320 (that is, the document element “Article 35” in the document “Patent Law”) is displayed in the left display region 350. Information on intracompany document elements 330 and 340 associated with the document element 320 is displayed in the right display region 360. The document element 330 is the document element “Article 4” in the document “Invention and Design Management Regulation”. A link to “Article 4” of “Invention and Design Management Regulation” in the intracompany regulation management system 20 is embedded in a document element name (that is, “Invention and Design Management Regulation—Article 4”) of the document element 330. A similarity degree display field 334 indicating a change in a degree of similarity between the document element 330 and the document element 320 displayed in the left display region 350 from the previous calculation result is illustrated on a right side of the document element name of the document element 330. In this example, the degree of similarity between the two document elements 320 and 330 is 0.6 in the previous calculation, but is decreased to 0.1 in the current calculation. This decrease in the degree of similarity is caused by the modification in the content of the document element 320 of interest.

A similarity degree display field 344 indicating a change in a degree of similarity between the document element 340 and the document element 320 in the left display region 350 from the previous calculation result is illustrated on a right side of the document element 340. The degree of similarity between the document elements 320 and 340 is 0.7 in the previous calculation, but is decreased to 0.4 in the current calculation.

The document elements 330 (that is, “Invent on and Design Management Regulation—Article 4”) and 340 that is, “00 document—Article XX”) are associated with the document element 320 (that is, “Patent Law—Article 35”), and has a high degree of similarity to the document element 320 before the modification. For example, since the document element 330 which is the article of the intracompany regulation includes intracompany rules associated with the document element 320 which is the article of the law and includes the description similar to the description of the document element 320, the degree of similarity of the content to the document element 320 is relatively high. Incidentally, in the illustrated example, apart of the content of the document element 320 which is strongly associated with the content of the intracompany document element 330 is modified by law revision, and as a result, the degree of similarity of the document element 330 to the document element 320 is greatly decreased. There is a high possibility that the content of the document element 330 of the intracompany regulation does not match the modified content of the document element 320 of the law. Thus, the user may perform an action of modifying the content of the document element 330 according to the modified content of the document element 320 or handling the document element 330 as an unassociated document to the modified document element 320. In the former case, the user accesses the document element 330 in the intracompany regulation management system 20 by using the link of the document element 330, and edits the content of the document element according to the modified content of the document element 320.

Meanwhile, an association deletion button 336 on which “degree of similarity to “Patent Law—Article 35” is not calculated in next calculation” is written is displayed as a user interface for the latter case under the similarity degree display field 334 corresponding to the document element 330 on the screen 300. The association deletion button 336 is an example of a graphical user interface (GUI) for instructing that the association of the document element 330 (that is, “Invention and Design Management Regulation—Article 4”) with the document element 320 (that is, “Patent Law—Article 35”) is canceled.

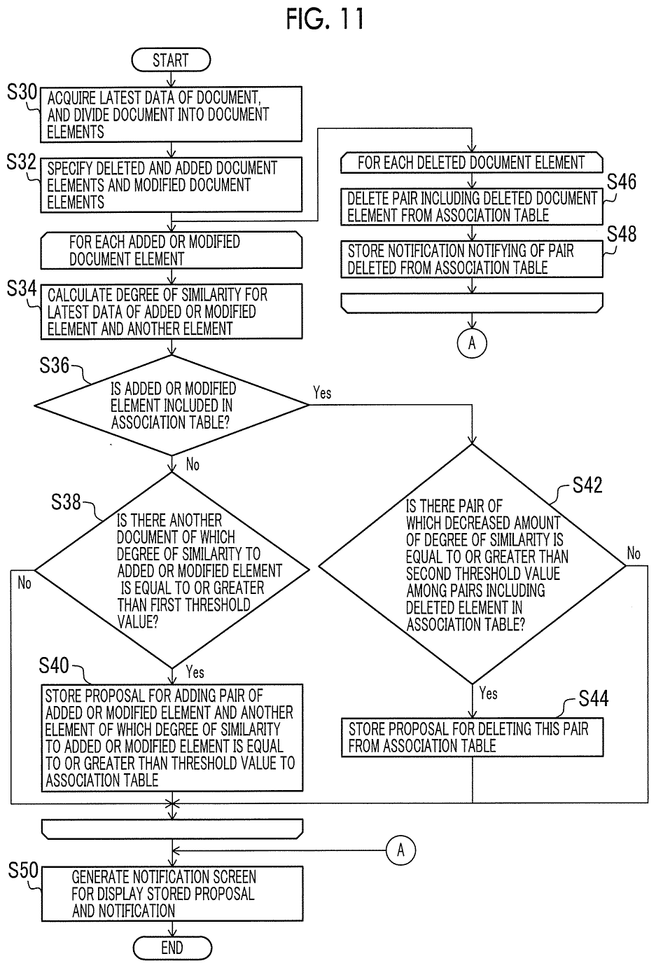

In this exemplary embodiment, in order to reduce the amount of calculation, other document elements of which the degrees of similarity to the document element of interest are calculated are usually limited to document elements registered in an association table (details will be described later) as being associated with the document element of interest. Since a plurality of documents is registered in the intracompany and extracompany document management systems and the number of document elements included in the plurality of documents are enormous, in a case where the degrees of similarity of all other document elements to the document element of interest are calculated, the amount of calculation is enormous. Thus, in this exemplary embodiment, a group of document element pairs that are associated with each other is registered in the association table, and the degrees of similarity between the document element and the document element of interest are calculated only for the document elements registered in the association table as being associated with the document element of interest. In one example, in a case where the degree of similarity between the document elements calculated at any timing is equal to or greater than a threshold value (that is, a first threshold value in a procedure of FIG. 11 to be described later), these document elements are registered in the association table as being associated with each other.

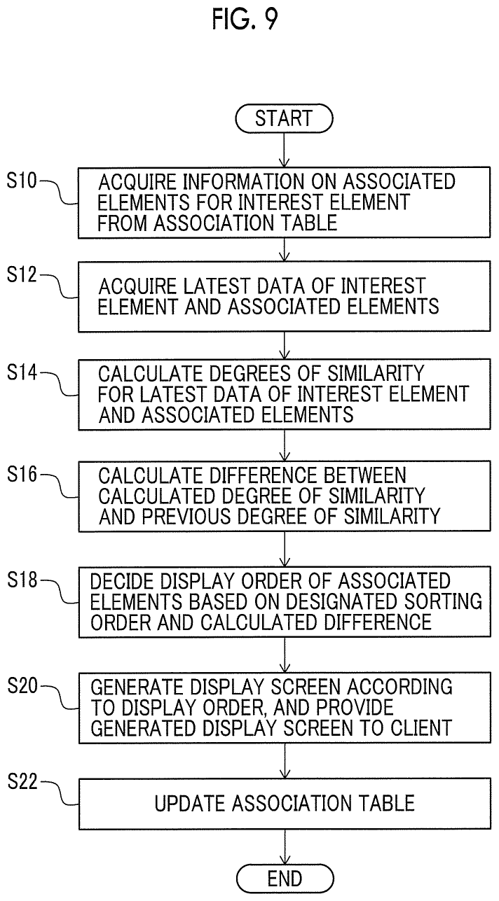

The association deletion button 336 is used to delete the association between the document element 330 and the document element 320 corresponding to the button 336 from the association table. In a case where the user presses the association deletion button 336 by performing a touch operation on the screen or performing an operation of a pointing device such as a mouse, the document service system 100 deletes information indicating the association between the document element 320 and the document element 330 from the association table. The degree of similarity between the two document elements 320 and 330 may not be calculated in a case where a procedure of FIG. 9 to be described later is executed for one of these document elements by deleting the association between the two document elements 320 and 330 from the association table.

The association deletion button 336 is displayed in a case where a decreased amount of the degree of similarity of the corresponding document element 330 to the document element 320 of interest from the previous calculation result is equal to or greater than a predetermined threshold value. For example, in a case where the threshold value is 0.4, in the example of FIG. 4, since the decreased amount of the degree of similarity of the document element 330 is 0.5 and is equal to or greater than the threshold value of 0.4, the association deletion button 336 corresponding to the document element 330 is displayed. In contrast, since the decreased amount of the degree of similarity of the document element 340 is 0.3 and is less than the threshold value of 0.4, the association deletion button corresponding to the document element 340 is not displayed.

In the example of FIG. 4, in the display region 360, the document elements 330 and 340 of the intracompany documents associated with the document element 320 of the extracompany document are sorted and arranged in descending order of the decreased amounts of the degrees of similarity from the previous calculation result. Information on another document element having a smaller decreased amount of the degree of similarity is displayed below the display of the document element 340 in the display region 360. The display regions 350 and 360 can be scrolled.

As the decreased amount of the degree of similarity of the document element 330 or 340 to the modified document element 320 becomes larger, the necessity to cope with the modification of the document element 330 or 340. In the example of FIG. 4, the document elements 330, 340, . . . are sorted and displayed in descending order of decreased amounts of the degrees of similarity. Thus, the necessity to cope with the modification of the content of the document element 320 becomes higher, the document element are displayed so as to rank high. Accordingly, the document elements are more likely to catch the eyes of the user.

The sorting order of the document elements 330, 340, . . . displayed in the display region 360 is represented in a sorting order designation field 362. The sorting order designation field 362 has a function of presenting a plurality of sorting orders in, for example, a pull-down menu format and accepting the selection of the sorting order intended by the user from among these sorting orders.

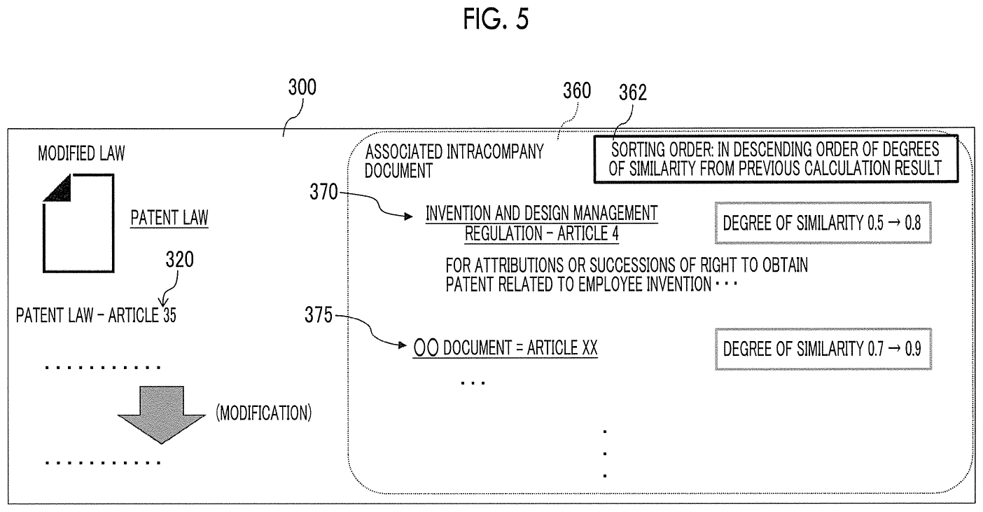

In FIG. 4, the intracompany document elements 330 and 340 associated with the extracompany document element 320 are sorted and displayed in descending order of the decreased amounts of the degrees of similarity from the previous calculation result to the current calculation result. In contrast, in the example illustrated in FIG. 5, the sorting orders are arranged in descending order of increased amounts of the degrees of similarity from the previous calculation result to the current calculation result. Before and after the modification of the extracompany document element 320, the degrees of similarity between intracompany document elements 370 and 375 associated with the document element 320 and the document element 320 are increased from 0.5 to 0.8 and from 0.7 to 0.9, respectively. The increased amount of the degree of similarity is 0.3 for the former document element, and is 0.2 for the latter document element.

There is a possibility that the paired document element 370 or 375 having a large increased amount of the degree of similarity to the modified document element 320 is strongly associated with the document element 320 before and after the modification of the document element 320, and it may be useful to inform the user of the document element 370.

For example, in a case where a memo indicating a private examination content on the assumption that the article of the law is revised is stored in the document management system in the intracompany network 40, the memo does not have a high degree of similarity to the text before the revision. However, in a case the directivity of the revision assumed in the memo is correct, it is considered that the degree of similarity between the revised text of the law and the memo is high. Thus, the user can recognize the presence of the memo and can take a measure such as drafting an official intracompany document by using the memo by notifying the user of the memo having a high degree of similarity after the revision of the text.

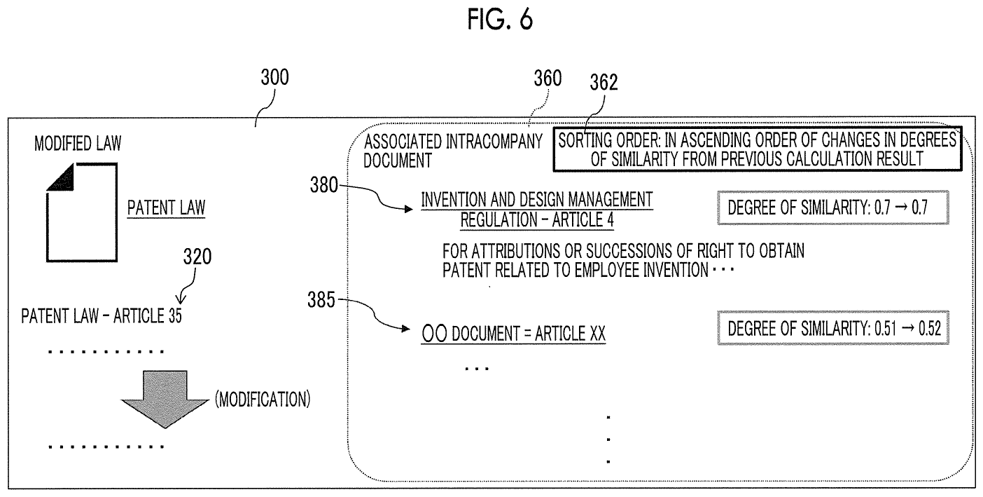

Thus, in the example of FIG. 6, the user selects the order in which the increased amount of the degree of similarity is large in the sorting order designation field 362. Accordingly, on the screen 300, document elements 380 and 385 having the large degrees of increase in the degree of similarity are displayed so as to rank high, and these document elements are more likely to catch the eyes of the user.

FIG. 6 illustrates an example of the screen 300 in a case where the order in which the amount of change in the degree of similarity from the previous calculation result to the current calculation result (that is, an absolute value of a difference between the degrees of similarity from the previous calculation result to the current calculation result) is small is designated in the sorting order designation field 362. In this example, the degree of similarity between the extracompany document element 320 and the intracompany document element 380 does not change before and after the modification of the extracompany document element. The degree of similarity between the document element 320 and the document element 385 is increased by 0.01.

Due to the designation of this sorting order, the user knows the intracompany document element of which the change in the degree of similarity to the document element 320 is small before and after the modification of the extracompany document element 320. For example, it is possible to distribute time such as checking the contents of the document elements later and checking other document elements.

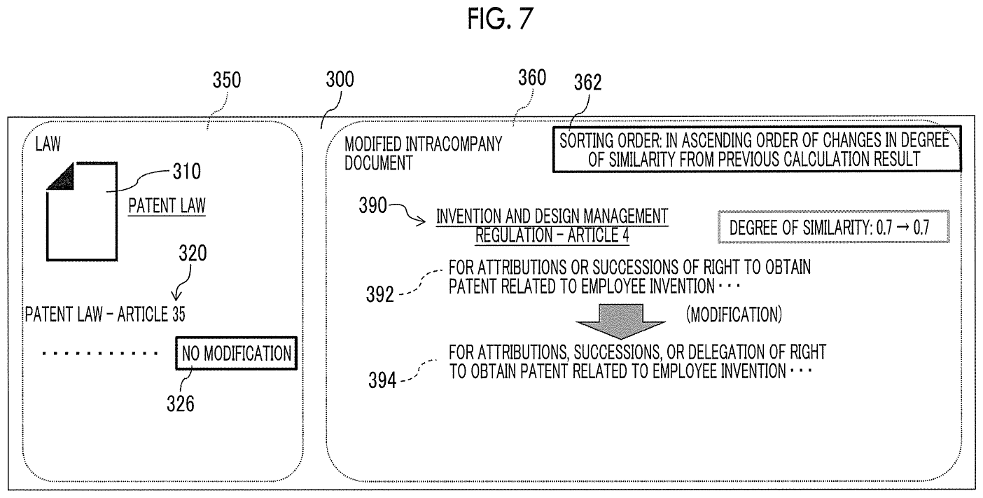

On the screen 300 illustrated in FIG. 7, the document element 320 of the extracompany document is not modified from the previous calculation result. Meanwhile, the intracompany document element 390 is modified from a previous content 392 to a current content 394. In this example, a display 326 indicating that the document element 320 is not modified is displayed in the display region 350. In this example, the degree of similarity between the document element 320 and the document element 390 is not changed before and after the modification of the document element 390.

As stated above, in a case where the intracompany document element 390 is modified, the document service system 100 provides the screen 300 displaying the extracompany document element 320 associated with the document element 390 and the information on the degree of similarity between these document elements.

Processing Executed by Document Service System

Next, processing executed by the document service system 100 in order to provide the screen 300 will be illustrated.

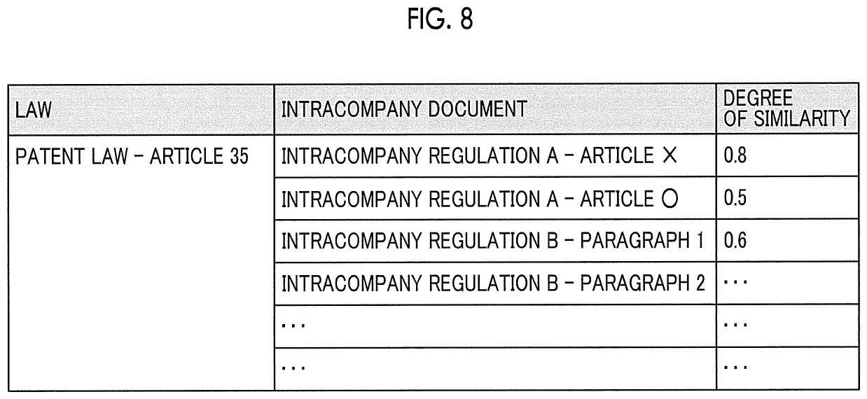

FIG. 8 illustrates a part of the association table managed by the document service system 100 for the processing.

The association table is a table in which pairs of extracompany document elements and intracompany document elements associated with each other are registered. There are enormous numbers of intracompany and extracompany document elements, and the number of pairs of intracompany and extracompany document elements associated with each other registered in the association table is enormous. In FIG. 8, information on the pair group including the extracompany document element “Patent Law—Article 35” is extracted from the association table, and is displayed. In the association table, the degree of similarity between two document elements configured to constitute the pair is registered for each pair. For example, the degree of similarity between the extracompany document element “Patent Law—Article 35” and the intracompany document element “Intracompany Regulation A—Article X” is 0.8.

The degree of similarity of the pair of document elements registered in the association table is the latest degree of similarity of the pair, that is, the degree of similarity obtained in the previous calculation.

The association table is stored in, for example, the auxiliary storage device 106 of the hardware configured to constitute the document service system 100. The association table stored in an external device of the document service system 100 may be referred to or modified by the document service system 100.

FIG. 9 illustrates a processing procedure executed by the document service system 100 to generate and provide the screen 300. This procedure is executed in a case where the user accesses the document service system 100 from the terminal (for example, the client 30) of the user, designates the document element of interest (hereinafter, also referred to as an “interest element”) to the document service system 100, and instructs that the screen 300 is displayed.

In this procedure, first, the processor 102 of the document service system 100 acquires information on the document element associated with the interest element (hereinafter, referred to as an “associated element”) from the association table (S10). In this step, the processor 102 searches for a pair including the interest element from the association table, and specifies, as the associated element, the document element that is paired with the interest element in each pair as a search result. Subsequently, the processor 102 acquires the latest contents of the interest element and each associated element obtained in step S10 from the document management system that stores each of these document elements (S12). The content of the document element retained in each document management system at a point in time of this acquisition is the latest content of the document element.

Subsequently, the processor 102 calculates, for each associated element, the latest degree of similarity between the associated element and the interest element from the acquired latest contents of the interest element and each associated element (S14). Here, for example, a degree of similarity between the contents of the document elements may be obtained by obtaining vectors of text strings included in the document elements and calculating a degree of similarity between the obtained vectors of the document elements by a known method (for example, cosine degree of similarity). An existing method such as Term Frequency-Inverse Document Frequency (TF-IDF) or doc2vec may be used as a method of obtaining the vector the text string of the document element.

Subsequently, the processor 102 calculates, for each associated element, a difference between the degree of similarity (that is, the previous degree of similarity) between the associated element read from the association table in step S10 and the interest element and the degree of similarity calculated in the current calculation in step S14 (S16). The calculated difference between the interest element and each associated element is stored in the memory 104.

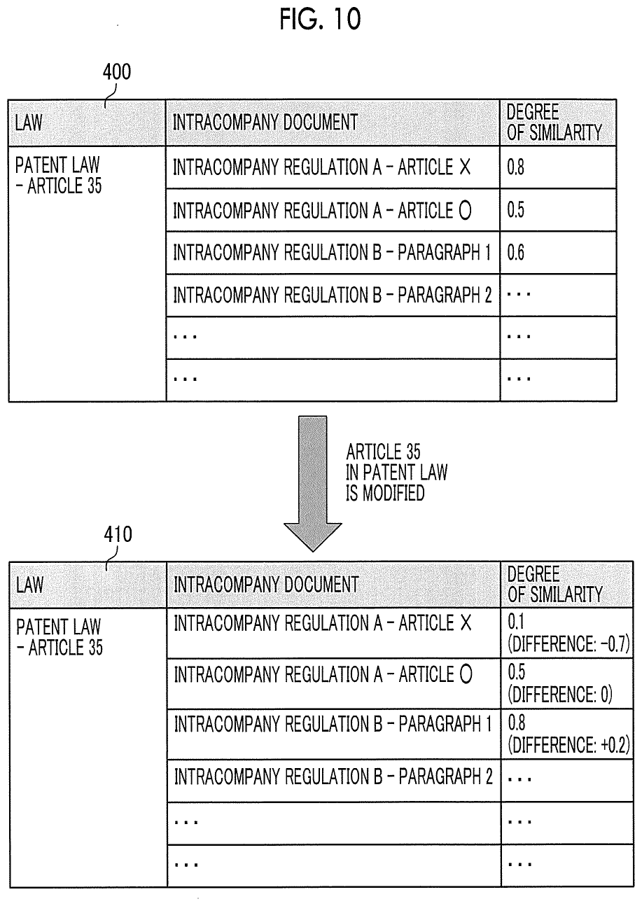

FIG. 10 illustrates a state 400 before the modification of the interest element and a state 410 after the modification at a part related to the extracompany document element “Patent Law—Article 35” which is the interest element in the association table. For example, the degree of similarity between the interest element and the associated element “Intracompany Regulation A—Article X” is 0.8 in the state 400 before the modification and is 0.1 in the state 410 after the modification. In step S16 of the procedure of FIG. 9, −0.7 which is the difference obtained by subtracting the former degree of similarity from the latter degree of similarity is obtained.

Subsequently, the processor 102 decides a display order of the associated elements in the display region 360 based on the sorting order (default order or the order designated by the user) represented in the sorting order designation field 362 and the difference in the degree of similarity obtained in S16 for each associated element (S18). For example, in a case where the sorting order designated by the user is a descending order of the decreased amounts of the degrees of similarity, the processor 102 sets, as the display order, an order in which the associated elements are arranged in ascending order of the differences in the degrees of similarity (that is, in an order in which the absolute values thereof are large in a case where the differences are negative).

Subsequently, the processor 102 generates the screen 300 on which the associated elements are arranged and displayed according to the display order decided in S18, and provides the screen 300 to the terminal of the user (S20). This screen 300 displays the contents of the interest element before and after the modification in the display region 350, and displays a group of associated elements in the display region 360 according to the display order obtained in S18. The processor 102 displays the association deletion button 336 in association with the display of the associated element on the screen 300 for the associated element of which the decreased amount of the degree of similarity to the interest element (that is, a value of the negative difference) is equal to or greater than a predetermined threshold value.

The processor 102 updates the degree of similarity of the pair of the interest element and each associated element in the association table to the latest degree of similarity calculated in S14 (S22).

Although the association table illustrated in FIG. 8 retains a value of the latest degree of similarity for each pair of the document elements, the association table may retain calculated values of a plurality of latest degrees of similarity for each pair of the document elements. In this case, in step S22, the processor 102 adds, as the latest value, the degree of similarity between the interest element calculated in S14 and each associated element to the association table.

In the example described with reference to FIGS. 4 to 10, the processor 102 decides the display order of the group of the associated elements based on the difference between the previous degree of similarity stored in the association table and the current degree of similarity calculated in S14. However, such decision is merely an example. Instead of such decision, in an example in which a plurality of past degrees of similarity is stored in the association table, the processor 102 may decide the display order of the group of associated elements based on a tendency (for example, a change rate) of changes in the latest degrees of similarity indicated by the plurality of past degrees of similarity and the current degrees of similarity. For example, there are several display modes in which the associated elements are sorted according to the change rate such as a display mode in which the associated elements are sorted in the order in which the change rate of the latest degrees of similarity is negative and the absolute value is large (that is, a decrease rate is large).

Maintenance of Association Table

Next, processing for performing maintenance of the association table will be described.

A group of the documents registered in the extracompany and intracompany document management systems is modified over time. The pair of the document elements determined to be associated at a certain point in time may be regarded as not being associated by the modification of the content of one or both of the document elements. In contrast, the pair of the document elements that are not associated with each other may be associated with each other by the modification of the content of one or both of the document elements. As stated above, a pair to be newly registered in the association table or a pair to be deleted from the association table occurs due to the modification of the document element. It is not realistic for humans to monitor the modification of the document element group and specify the pair to be registered in or the pair to be deleted from the association table. Thus, in this exemplary embodiment, the document service system 100 monitors groups of the intracompany and extracompany document management systems, obtains the pair of the document elements to be newly added to the association table or the pair of the document elements to be deleted from the association table, and proposes the obtained pair to the user. The user determines whether or not to the proposal from the document service system 100 is appropriate, and instructs that the pair is added to or deleted from the association table.

FIG. 11 illustrates a processing procedure of the document service system 100 for performing the maintenance of this association table. In this example, the processor 102 of the document service system 100 monitors each document management system, for example, periodically. The processor 102 executes a processing procedure of FIG. 11 for each document retained in the document management system to be monitored by using the document as a processing target.

In this procedure, the processor 102 acquires the latest data of the document as the processing target, and divides the acquired latest data into document element units (S30).

Subsequently, the processor 102 specifies the document element of which the content is modified, the document element newly added to the document, and the document element deleted from the document based on the information on each document element obtained as a result of the division (S32).

In order to perform this specification, the document service system 100 stores data indicating the content of each document element at a point in time of the previous acquisition of the document, for example, in the auxiliary storage device 106. In other words, the document service system 100 retains data indicating the latest content of the document acquired in S12 of the procedure of FIG. 9 or S30 of the procedure of FIG. 11 for each document element of the document retained by each document management system. The data indicating the content of each document element may be the content of the document element, or may be data (for example, a hash value) indicating a feature of the content.

In step S32, the processor 102 determines whether or not there is the document element corresponding to the document element (hereinafter, referred to as a “document element A”) obtained in step S30 among the group of the document elements of the document stored in the document service system 100 at a point in time of the previous acquisition. For example, this determination is performed by investigating whether or not there is the document element having identification information identical to the document element A among the group of the document elements at the point in time of the previous acquisition. For example, a combination of the document name of the document including the document element and the element name (for example, an article number or a title of the document element) of the document element may be used as the identification information of the document element. The identification information may be used for the document element in the document management system that manages each document element by giving unique identification information to the document element. In a case where it is determined that there is the document element corresponding to the document element A among the group of the document elements at the point in time of the previous acquisition, the processor 102 determines whether or not the document element A is modified by comparing the content of the document element A with the content of the document element at the point in time of the previous acquisition. In a case where there is no document element having the identification information identical to the document element A among the group of the document elements at the point in time of the previous acquisition, the processor 102 determines that the document element A is newly added to the document. In a case where there is no document element having the identification information identical to the document element at the point in time of the previous acquisition among the document elements obtained in step S30, the processor 102 determines that the document element is deleted in the current calculation.

The processor 102 executes the processing of S34 to S44 for each of the added document element or the modified document element specified in S32.

In S34, the processor 102 calculates the degree of similarity between the content of the added or modified document element (hereinafter, referred to as the element) as the processing target and the latest content of each of the other document elements stored in the document service system 100. Here, in a case where the element is the extracompany element, the paired document element for which the degree of similarity is calculated is limited to the intracompany document element, and in a case where the element is the intracompany element, the paired document element for which the degree of similarity is calculated may be limited to the extracompany document element.

Subsequently, the processor 102 determines whether or not the pair including the element is included in the association table (S36). In a case where the pair including the element is not included in the association table (the determination result of S36 is No), the processor 102 determines whether or not there is the document element of which the degree of similarity to the element calculated in S34 is equal to or greater than a predetermined first threshold value among the other document elements (S38). In a case where the determination result of step S38 is Yes, the processor 102 generates proposal data indicating a proposal for adding a pair of another document element and the element to the association table for each other document element of which the degree of similarity to the element is equal to or greater than the first threshold value, and stores the generated proposal data in the memory 104 (S40). In a case where the determination result of step S38 is No, the processor 102 skips S40.

In a case where the determination result of step S36 is Yes, the processor 102 determines whether or not there is the pair of which the decreased amount of the degree of similarity is equal to or greater than a predetermined second threshold value in the pair including the element in the association table (S42). In a case where the determination result of step S42 is Yes, the processor 102 generates proposal data indicating a proposal for deleting the pair of which the decreased amount of the degree of similarity is equal to or greater than the predetermined second threshold value from the association table, and stores the generated proposal data in the memory 104 (S44). In a case where the determination result of step S42 is No, the processor 102 skips S44. The second threshold value used in the determination of step S42 may be a value identical to the threshold value used in the determination of whether or not to display the association deletion button 336 on the screen 300, or may be a different value.

The processor 102 uses the deleted document element specified in S32 as the processing target, and executes the processing of S46 to S48. That is, the processor 102 searches for the pair including the document element as the processing target from the association table, and deletes the pair from the association table in a case where such a pair is found (S46). In a case where the document element that is not deleted from the pair is selected as the interest element in the processing procedure of FIG. 9 by deleting the pair from the association table, the processing (for example, steps S10 to S14) for calculating the degree of similarity to the deleted document element may not be tried. The processor 102 generates notification data notifying of the pair deleted from the association table, and stores the generated notification data in the memory 104 (S48). In a case where the pair including the document element as the processing target is not in the association table, the processor 102 does not execute S46 and S48 for the document element.

After steps S40, S44, and S48 are executed, the processor 102 generates a notification screen on which the proposal data and the notification data stored in the memory 104 during the execution of the processing procedure of FIG. 11 is displayed (S50). The generated notification screen is provided and displayed on the terminal of the user in a case where the user logs in to the document service system 100.

Although the procedure of FIG. 11 is an example in which step S50 (that is, notification screen generation processing) is executed whenever one document is acquired, this procedure is merely an example. As another example, the processor 102 may execute step S50 after the processing of steps S30 to S48 is ended for all the documents in all the document management systems monitored by the document service system 100, for example. In addition, as an example of a timing at which step S50 is executed, there may be various timings at which the processing of steps S30 to S48 is executed for all the documents in one document management system, the processing of steps S30 to S48 is executed for a predetermined number of documents, or the processing of steps S30 to S48 is executed on the document acquired during a predetermined time.

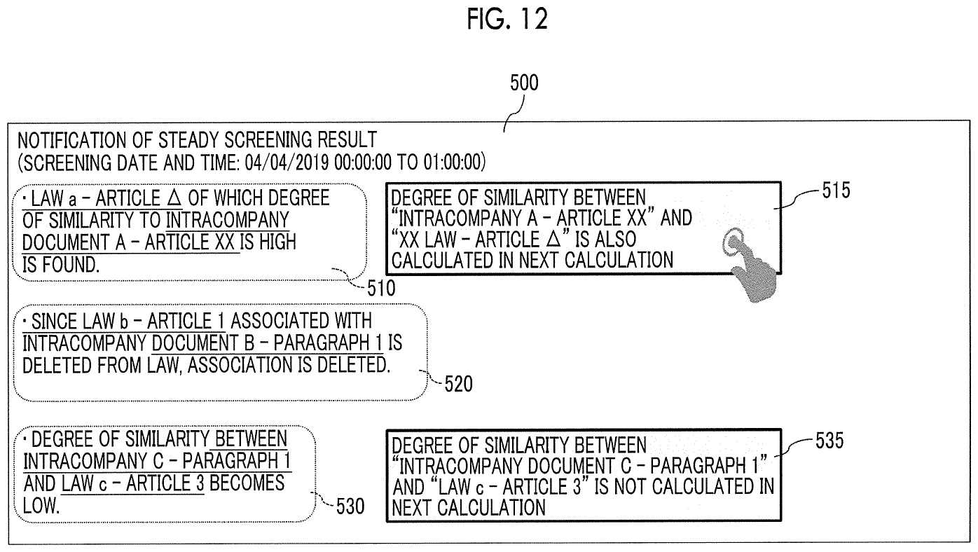

FIG. 12 illustrates a notification screen 500 generated in step S50. In this example, the notification screen is generated by executing step S50 after the processing of S30 to S48 is executed for the documents acquired from the group of the document management systems at a specific time. In the illustrated notification screen 500, the processing illustrated in FIG. 11 is called “steady screening”.

A display item 510 and an association addition button 515 displayed on the notification screen 500 are examples of the proposal data for proposing addition to the association table generated in step S40. The display item 510 includes news indicating that it is found that the degree of similarity between the pair of the document element “Intracompany Document A—Article XX” and the document element “Law a—Article A” that are not registered in the association table is equal to or greater than the first threshold value. The association addition button 515 is an example of a GUI component for receiving an instruction to add the pair to the association table. In a case where the user presses the association addition button 515 by a touch operation, the processor 102 adds the pair to the association table.

A display item 520 is an example of the notification data which is generated in step S48 and notifies of the pair deleted from the association table. The display item 520 includes news indicating that the pair of the document element “Law b—Article 1” and the document element “Intracompany Document B—Paragraph 1” is deleted from the association table since the document element “Law b—Article 1” is deleted.

A display item 530 and an association deletion button 535 are examples of the proposal data which is generated in step S44 and proposes the deletion from, the association table. The display item 530 includes news indicating that the decreased amount of the degree of similarity of the pair of the document element “Intracompany Document C—Paragraph 1” and the document element “Law c—Article 3” is equal to or greater than the second threshold value from the previous calculation result. The association deletion button 535 is an example of a GUI component for receiving an instruction to delete the pair from the association table. In a case where the user presses the association deletion button 535 by a touch operation, the processor 102 deletes the pair from the association table.

Although it has been described in the example of FIG. 11 that the addition or deletion of the pair of the document elements to or from the association table is proposed based on the value of the degree of similarity or the decreased amount of the degree of similarity, this proposal is merely an example. For example, the document service system 100 may store the plurality of past degrees of similarity calculated in the processing of FIG. 11 or FIG. 4 for each pair in a sequence of time, and may use information on the plurality of past degrees of similarity. That is, the addition or deletion of the pair may be proposed based on the tendency of changes in the latest degrees of similarity indicated by the plurality of past degrees of similarity and the current degree of similarity obtained in the processing of FIG. 11. For example, even though the current degree of similarity is less than the first threshold value for the pair illustrating the tendency of increases in the latest degrees of similarity up to the current, the proposal data for the addition to the association table may be generated in S40. For example, even though the decreased amount of the degree of similarity from the previous calculation result is less than the second threshold value for the pair illustrating the tendency of decreases in the latest degrees of similarity up to the current calculation result, the proposal data for the addition to the association table may be generated in S40.

Although it has been described in the above example that the screen 300 is generated according to the change in the degree of similarity between the extracompany document element and the intracompany document element, the screen 300 may be generated according to the changes in the degrees of similarity between various document elements without distinguishing between the extracompany and intracompany document elements.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage device; and
a processor configured to
execute calculation of degrees of similarity between an interest document element and document elements associated with the interest document element for each associated document element, and
execute display control for the associated document elements based on the degrees of similarity between the associated document elements and the interest document element obtained by the calculation and past degrees of similarity stored in the storage device.

2. The information processing apparatus according to claim 1,
wherein, in the display control, a display order in a list display of the associated document elements is controlled.

3. The information processing apparatus according to claim 2,
wherein the display order is obtained based on changes in the degrees of similarity obtained by the calculation from the past degrees of similarity.

4. The information processing apparatus according to claim 2,
wherein the display order is an order in which the associated document element having a larger decreased amount of the degree of similarity obtained by the calculation from the past degree of similarity ranks high.

5. The information processing apparatus according to claim 1,
wherein the processor is configured to perform control such that a user interface component for canceling the association of the associated document element with the interest document element for the associated document element of which a decreased amount of the degree of similarity obtained by the calculation from the past degree of similarity is equal to or greater than a threshold value is displayed.

6. The information processing apparatus according to claim 2,
wherein the processor is configured to perform control such that a user interface component for canceling the association of the associated document element with the interest document element for the associated document element of which a decreased amount of the degree of similarity obtained by the calculation from the past degree of similarity is equal to or greater than a threshold value is displayed.

7. The information processing apparatus according to claim 3,
wherein the processor is configured to perform control such that a user interface component for canceling the association of the associated document element with the interest document element for the associated document element of which a decreased amount of the degree of similarity obtained by the calculation from the past degree of similarity is equal to or greater than a threshold value is displayed.

8. The information processing apparatus according to claim 4,
wherein the processor is configured to perform control such that a user interface component for canceling the association of the associated document element with the interest document element for the associated document element of which a decreased amount of the degree of similarity obtained by the calculation from the past degree of similarity is equal to or greater than a threshold value is displayed.

9. The information processing apparatus according to claim 1,
wherein the processor is configured to perform control such that a user interface component for canceling the association of the associated document element with the interest document element for the associated document element of which the degree of similarity obtained by the calculation is less than a second threshold value is displayed.

10. The information processing apparatus according to claim 2,
wherein the processor is configured to perform control such that a user interface component for canceling the association of the associated document element with the interest document element for the associated document element of which the degree of similarity obtained by the calculation is less than a second threshold value is displayed.

11. The information processing apparatus according to claim 3,
wherein the processor is configured to perform control such that a user interface component for canceling the association of the associated document element with the interest document element for the associated document element of which the degree of similarity obtained by the calculation is less than a second threshold value is displayed.

12. The information processing apparatus according to claim 4,
wherein the processor is configured to perform control such that a user interface component for canceling the association of the associated document element with the interest document element for the associated document element of which the degree of similarity obtained by the calculation is less than a second threshold value is displayed.

13. The information processing apparatus according to claim 5,
wherein the processor is configured to perform control such that a user interface component for canceling the association of the associated document element with the interest document element for the associated document element of which the degree of similarity obtained by the calculation is less than a second threshold value is displayed.

14. The information processing apparatus according to claim 6,
wherein the processor is configured to perform control such that a user interface component for canceling the association of the associated document element with the interest document element for the associated document element of which the degree of similarity obtained by the calculation is less than a second threshold value is displayed.

15. The information processing apparatus according to claim 7,
wherein the processor is configured to perform control such that a user interface component for canceling the association of the associated document element with the interest document element for the associated document element of which the degree of similarity obtained by the calculation is less than a second threshold value is displayed.

16. The information processing apparatus according to claim 8,
wherein the processor is configured to perform control such that a user interface component for canceling the association of the associated document element with the interest document element for the associated document element of which the degree of similarity obtained by the calculation is less than a second threshold value is displayed.

17. The information processing apparatus according to claim 2,
wherein the display order is an order in which the associated document element having a large increased amount of the degree of similarity obtained by the calculation from the past degree of similarity ranks high.

18. The information processing apparatus according to claim 1,
wherein the processor is configured to calculate a degree of similarity between document elements included in a pair for each pair of the document elements included in a document element group that includes the interest document element, the associated document element, and another document element, and
perform control such that a user interface component for associating the document elements included in the pair is displayed in a case where the degree of similarity calculated for the pair is equal to or greater than a threshold value.

19. The information processing apparatus according to claim 1,
wherein the processor is configured to, in a case where the document element is deleted, cancel the association of another document element with the canceled document element.

20. A non-transitory computer readable medium storing a program causing a computer to function to;
execute calculation of degrees of similarity between an interest document element and document elements associated with the interest document element for each associated document element, and
execute display control for the associated document elements based on the degrees of similarity between the associated document elements and the interest document element obtained by the calculation and past degrees of similarity stored in a storage device.
